(19) United States
(12) Patent Application Publication
(10) Pub. No.: US 2015/0186974 A1
(43) Pub. Date: Jul. 2, 2015

(54) Techniques For Searching Using Market-Adjusted Statistics

(71) Applicant: Quixey, Inc., Mountain View, CA (US)

(72) Inventors: Abdelhalim Abbas, San Jose, CA (US); Eric Glover, Sunnyvale, CA (US)

(21) Appl. No.: 14/144,303

(22) Filed: Dec. 30, 2013

(51) Int. Cl. G06Q 30/06; G06Q 20/12

(52) U.S. Cl. CPC G06Q 30/0627; G06Q 20/123

(57) ABSTRACT

A method includes performing a search of an application data store using a search query. The application data store includes application data for a plurality of software applications available from a software-application marketplace. The application data includes a set of application statistics for each software application. Each set of application statistics includes statistical data points over time. The application data also includes a set of market-wide statistics that is an aggregate of the sets of application statistics over time. The method further includes generating a list of software applications identified during the search. Additionally, the method includes generating a result score for each software application in the list based on a set of market-adjusted statistics associated with the software application. The set of market-adjusted statistics associated with a software application is the set of application statistics associated with the software application adjusted by the set of market-wide statistics.

### BACKGROUND

1. Field of Art

The disclosure generally relates to the field of search, and more particularly to performing searches for digital goods using statistics associated with the digital goods.

2. Description of the Related Art

In recent years, use of computers, smartphones, and other Internet-connected devices has grown exponentially. Correspondingly, the number of available digital goods (e.g., software applications) for such devices has also grown. Today, many diverse types of digital goods can be accessed on any number of different devices, including, but not limited to, smartphones, personal computers, automobiles, and televisions. These diverse digital goods can include digital music, digital videos, digital books, business driven applications, games, educational applications, news applications, shopping applications, messaging applications, media streaming applications, social networking applications, and so much more.

### BRIEF DESCRIPTION OF DRAWINGS

The details of one or more examples are set forth in the accompanying drawings and the description below. Other features, objects, and advantages will be apparent from the description and drawings, and from the claims.

FIG. 1 is a functional block diagram illustrating an example environment including a search system configured to perform searches for software applications.

FIGS. 2A-2B show example data that may be stored in an application data store.

FIG. 3 is a graph that shows example market-wide download statistics, application download statistics, and market-adjusted download statistics.

FIG. 4 shows an example method for generating application scoring features based on market-adjusted statistics.

FIG. 5 shows an example application search module that may be included in the search system of FIG. 1.

FIG. 6 shows an example method for performing an application search based on a received search query.

FIGS. 7-8 show example scenarios in which using application scoring features based on market-adjusted statistics may yield additional information that may be relevant to generating search results.

FIG. 9 is a functional block diagram illustrating an example environment including a digital-goods search system configured to perform searches for digital goods.

FIGS. 10A-10B show example data that may be stored in a digital-goods data store.

FIG. 11 shows an example method for generating digital-good scoring features based on market-adjusted statistics.

FIG. 12 shows an example method for performing a search for digital goods based on a received search query.

### DETAILED DESCRIPTION

The figures and the following description relate to example implementations by way of illustration only. It should be noted that from the following discussion, alternative implementations of the structures and methods disclosed herein will be readily recognized as viable alternatives that may be employed without departing from the scope of the disclosure.

The present disclosure relates to searches for software applications (i.e., “applications”) and other digital goods. A search system of the present disclosure receives a search query from a user's computing device (e.g., a mobile computing device). The search system generates search results in response to the received search query. The search results may include a list of applications and result scores associated with the applications. The result scores may be used to rank the applications in the list. For example, a larger result score associated with an application may indicate that the application is more relevant to the received search query. The search system may transmit the search results to the user's computing device so that the user may select one of the applications to preview and/or download.

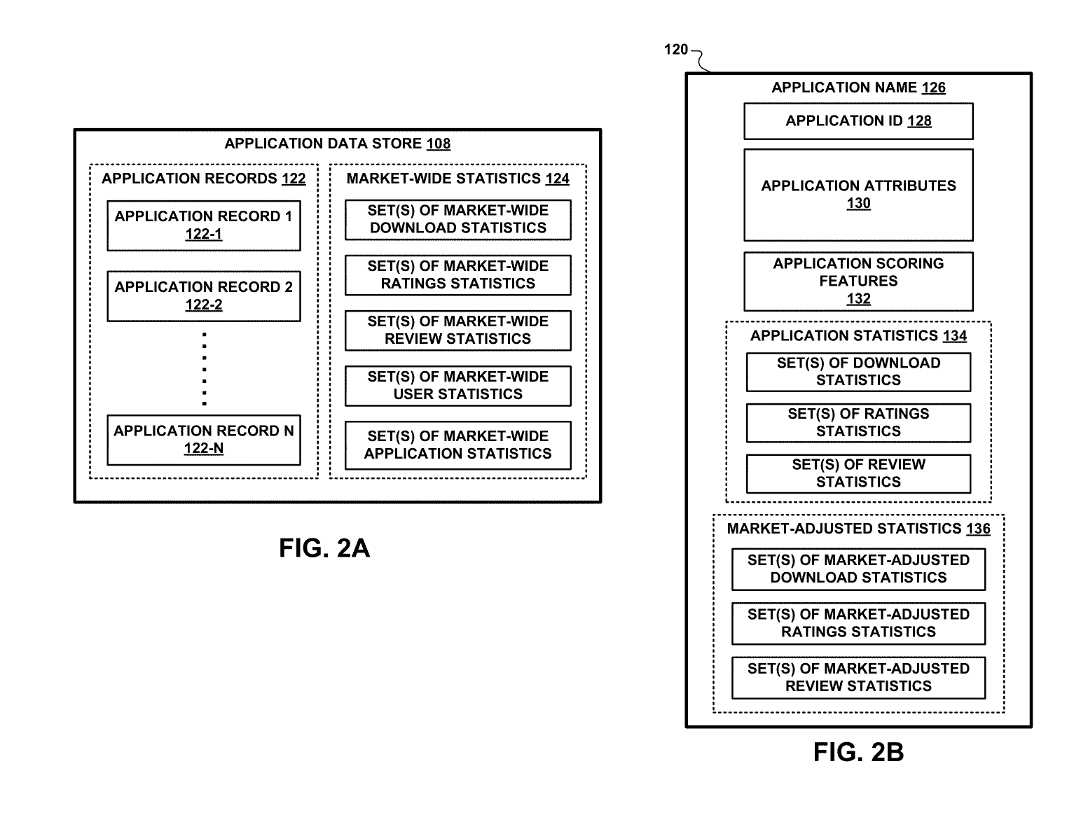

The search system includes an application data store which the search system may use to generate the search results. The application data store includes data associated with a plurality of different applications. The data associated with an application may be referred to herein as an “application record” (e.g., application record 120 of FIG. 2B). The application data store may include a plurality of different application records that each include data related to a different application. In some implementations, the application data store may not store the applications (e.g., the executable programs) described by the application records. Instead, the applications may be accessed on one or more application marketplaces that are configured to distribute the applications.

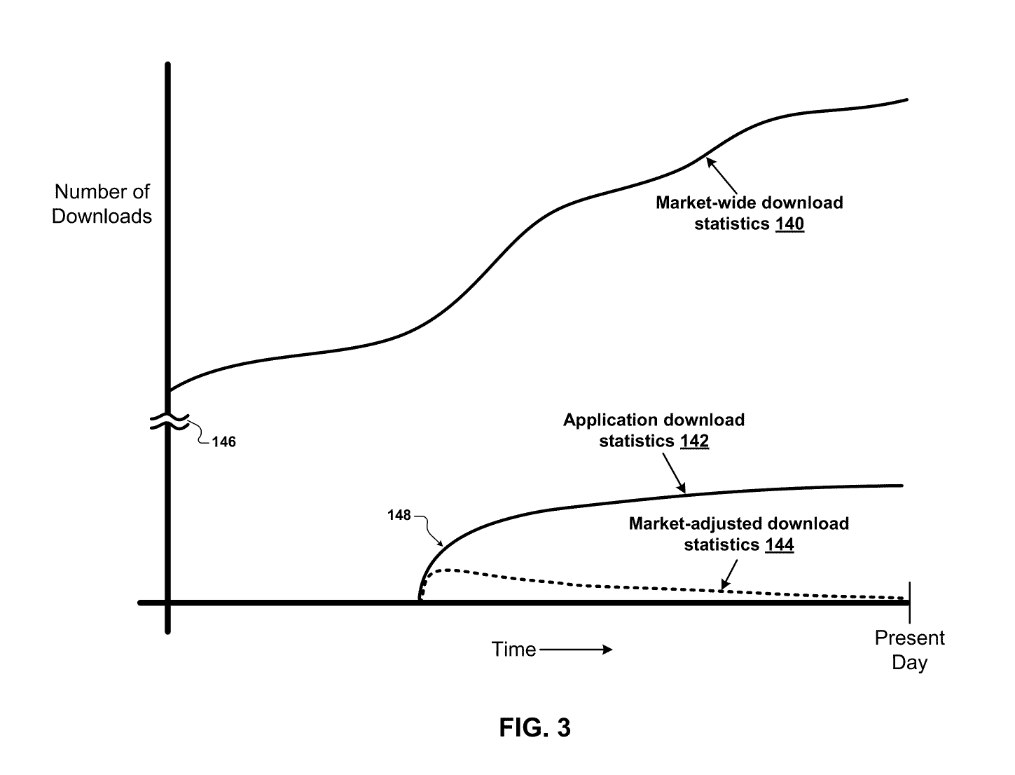

An application record may include a variety of different types of data related to an application. In some implementations, an application record may include the name of the application, the developer of the application, a description of the application, and a category of the application, along with other data described herein. An application record also includes one or more sets of application statistics. Application statistics may refer to any numerical data related to the application. Application statistics may be numerical data associated with the application over a period of time. As such, application statistics may include multiple data points (e.g., statistical samples) at different points in time. For example, a set of application statistics may include numerical data associated with the application from the time the application was introduced to an application marketplace until the present day. As example statistics, a set of application download statistics may include data points indicating a number of downloads of the application at different points in time. Example graphs of application statistics versus time are illustrated in FIG. 3 and FIGS. 7-8.

As described above, the search system may generate a result score for each of the applications in the search results. The search system may generate results scores for applications based on a variety of different factors. For example, the search system may generate result scores for applications based on one or more scoring features, which may be associated with the application and/or the search query. The scoring features may be query scoring features, application-query scoring features, and application scoring features. Query scoring features may include data associated with the search query. Application-query scoring features may refer to data associated with both the application and the query. Application scoring features may refer to data associated with the application.

The search system generates application scoring features based on statistics included in the application data store. Accordingly, the search system generates result scores based on statistics included in the application data store. The search system may generate application scoring features based on market-adjusted statistics. Market-adjusted statistics may be determined for an application based on statistics associated with the application and market-wide statistics associated with a defined market (e.g., an application marketplace).

Market-wide statistics may refer to an aggregate of application statistics across a plurality of different applications. In one implementation, market-wide statistics for an application marketplace may refer to the statistical totals (e.g., total downloads) across all of the applications available from the application marketplace. In this implementation, market-wide statistics may represent the size of an application marketplace over time in terms of total downloads, total ratings, and total reviews, for example.

Market-wide statistics for an application marketplace may change over time. For example, the total number of downloads from the application marketplace will increase over time as more users download applications from the application marketplace. The significance of application statistics (e.g., application downloads) for an application within the application marketplace may also change over time, depending on how the market-wide statistics vary. For example, application downloads that occurred in the past may be more significant than those that occur in the present day since the number of market-wide downloads increases over time. Put another way, application downloads that occurred in the past may have made up a more significant portion of market-wide downloads since the number of market-wide downloads were fewer in the past. The search system of the present disclosure takes into account the changes in market-wide statistics over time, along with the associated changes in the significance of application statistics over time.

The search system generates market-adjusted statistics based on market-wide statistics and application statistics. For example, the search system may generate market-adjusted statistics by adjusting the application statistics over a time period with market-wide statistics over the same time period. The search system may generate market-adjusted statistics by normalizing (e.g., dividing) the application statistics by market-wide statistics over the same time period. After determining the market-adjusted statistics, the search system may incorporate the market-adjusted statistics into scoring features used to generate result scores for applications. By using market-adjusted statistics when generating result scores for applications, the search system takes into account the changes in market-wide statistics over time, along with the associated changes in the significance of application statistics over time.

Market-adjusted statistics may yield additional information about an application that may not be apparent from application statistics which are not adjusted by market-wide statistics. Accordingly, application scoring features based on market-adjusted statistics may provide additional information which the search system may use to score and rank application search results. Techniques for generating application statistics, market-wide statistics, and market-adjusted statistics, along with scoring applications using market-adjusted statistics, are described hereinafter in greater detail.

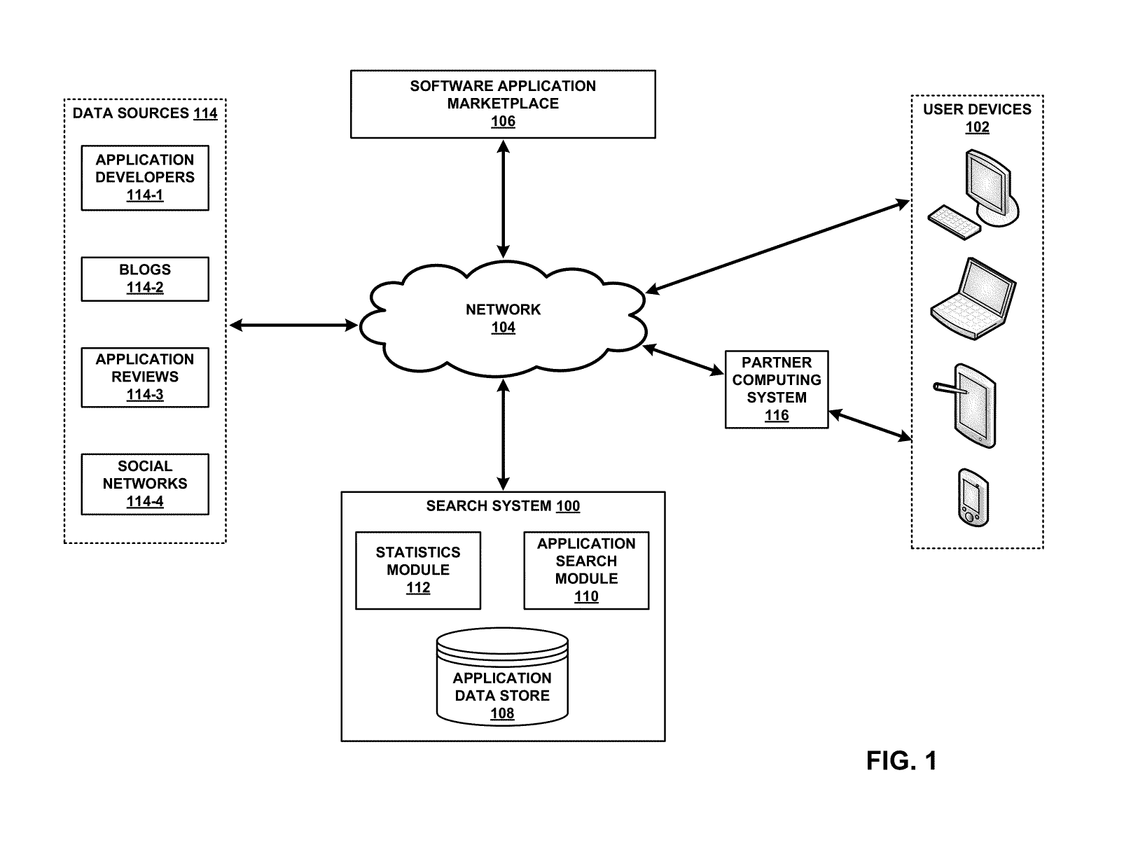

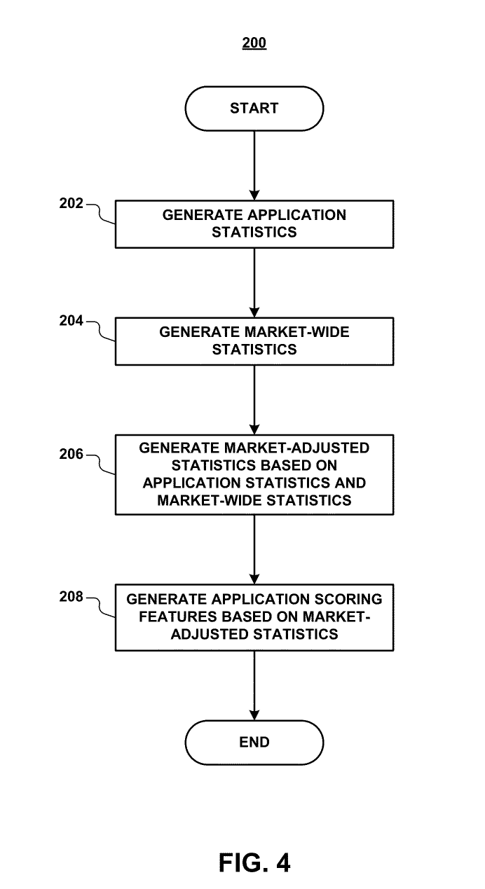

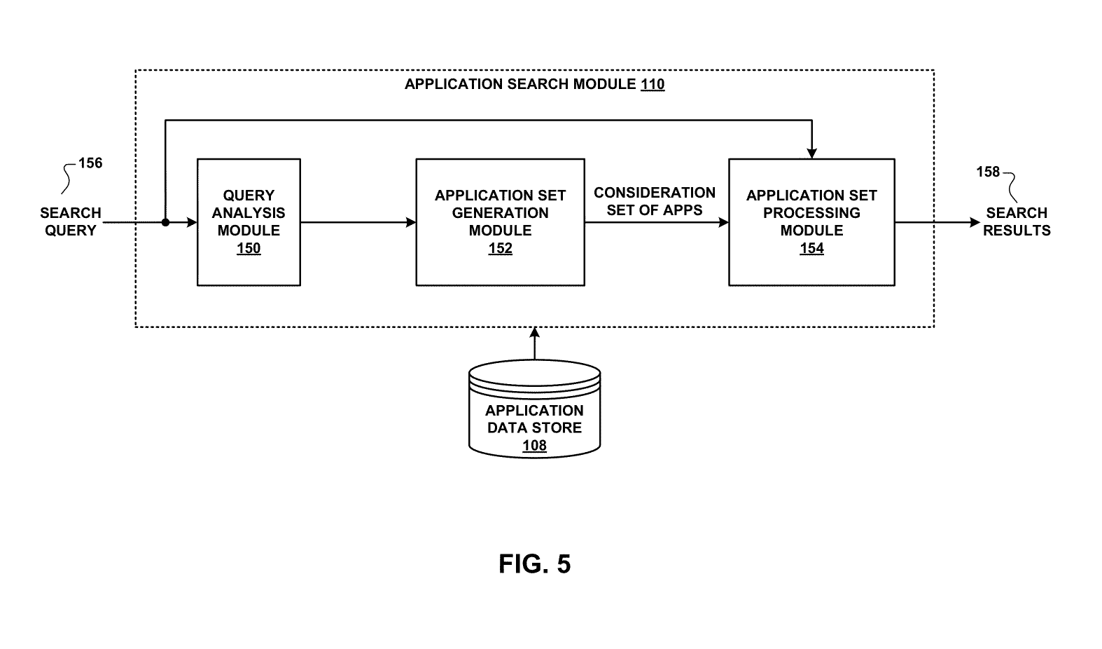

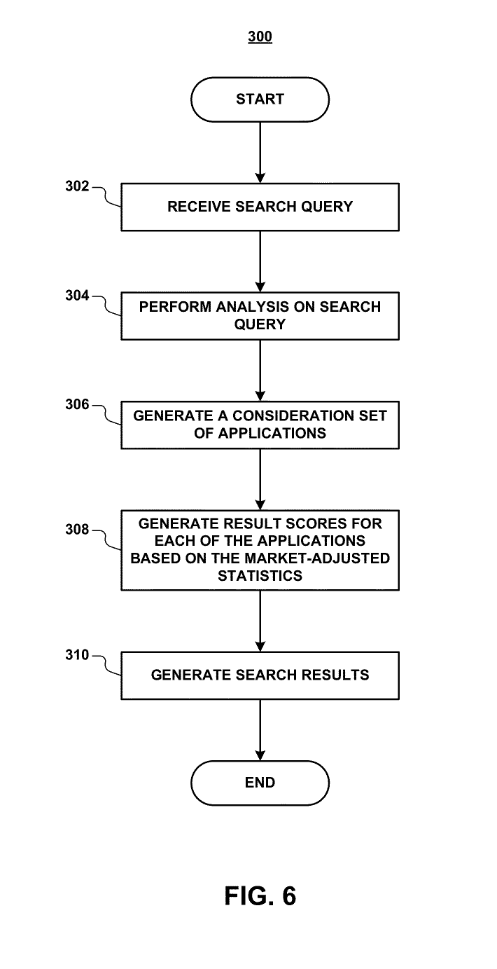

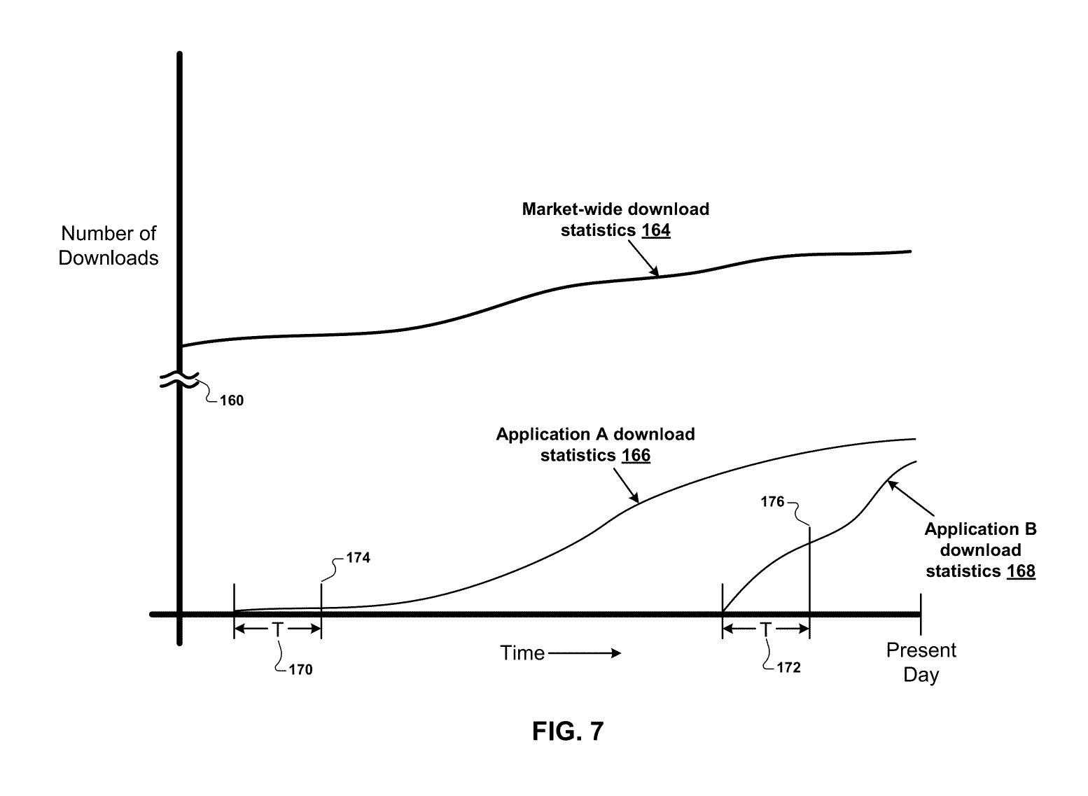

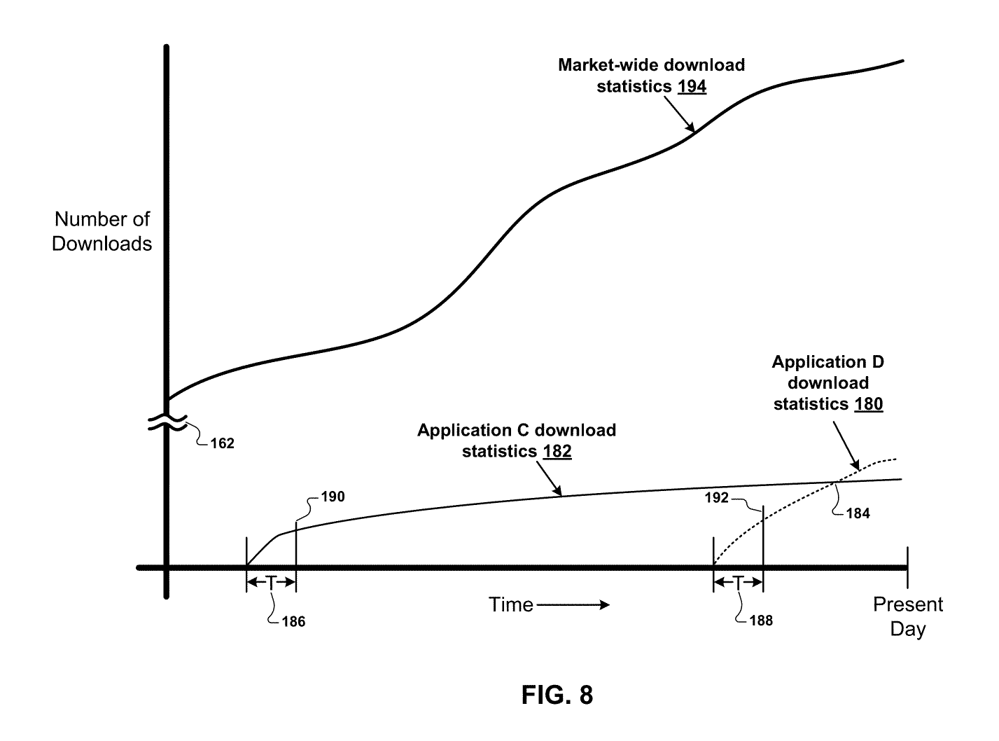

Techniques for performing application searches are described hereinafter with reference to FIGS. 1-8. FIG. 1 illustrates an example environment including a search system configured to perform searches for software applications. FIGS. 2A-2B show data (e.g., application records) which may be stored in an application data store. FIG. 3 shows a graph of example application statistics, market-wide statistics, and market-adjusted statistics. FIG. 4 shows an example method for generating application scoring features based on market-adjusted statistics. FIGS. 5-6 describe an application search module and method for performing application searches based on a received search query. FIGS. 7-8 show two example scenarios in which using application scoring features based on market-adjusted statistics may yield additional information which may be relevant to generating search results.

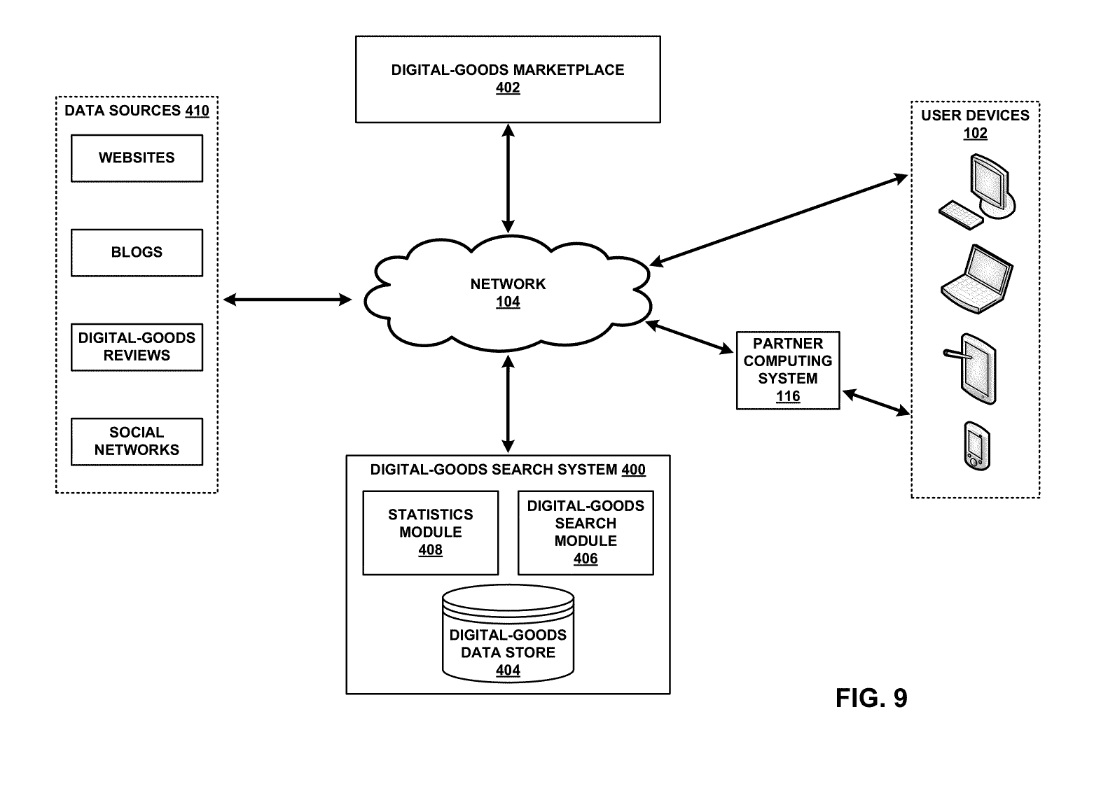

The techniques for performing application searches described herein may also be applied to searches for digital goods other than software applications. For example, a digital-goods search system may be configured to search for digital goods, such as digital music files, digital videos (e.g., movies and television shows), and digital books. A digital-goods search system may receive a search query from a user's computing device (e.g., a mobile computing device) and generate search results in response to the received search query. The search results may include a list of digital goods (e.g., digital music files, videos, and/or books) which may be ranked based on a variety of different factors (e.g., relevance). In some implementations, the digital-goods search system transmits the search results in the form of a list of digital goods to the user so that the user may select one of the digital goods to preview and/or download. Techniques for performing searches for digital goods are described herein with reference to FIGS. 9-12.

FIG. 1 is a functional block diagram illustrating an example environment including a search system 100 configured to perform searches for software applications. A software application may refer to computer software that causes a computing device to perform a task. In some examples, a software application may be referred to as an “application”, an “app”, or a “program”. Example applications include, but are not limited to, word processing applications, spreadsheet applications, messaging applications, media streaming applications, social networking applications, and games.

Applications can be executed on a variety of different computing devices. For example, applications can be executed on mobile computing devices such as smart phones, tablets, and wearable computing devices (e.g., headsets and/or watches). Applications can also be executed on other types of computing devices having other form factors such as laptop computers, desktop computers, or other consumer electronic devices. In some examples, applications may be installed on a computing device prior to a user purchasing the computing device. In other examples, the user may download and install applications on the computing device.

The functionality of an application may be accessed on the computing device on which the application is installed. Additionally, or alternatively, the functionality of an application may be accessed via a remote computing device. In some examples, all of an application's functionality may be included on the computing device on which the application is installed. These applications may function without communication with other computing devices (e.g., via the Internet). In other examples, an application installed on a computing device may access information from other remote computing devices during operation. For example, a weather application installed on a computing device may access the latest weather information via the Internet and display the accessed weather information to the user through the installed weather application. In still other examples, an application (e.g., a web based application) may be partially executed by the user's computing device and partially executed by a remote computing device. For example, a web application may be an application that is executed, at least in part, by a web server and accessed by a web browser of the user's computing device. Example web applications may include, but are not limited to, web-based email, online auctions, and online retail sites.

The search system 100 is configured to receive search queries from one or more user device(s) 102 via a network 104. The search system 100 performs a search for applications in response to a received search query. The search system 100 may generate a set of search results that includes a list of applications, each of which is associated with a result score that indicates the rank of the application relative to the other applications in the list. A list may comprise any listing, set, or grouping of applications, which may be ordered or ranked, and may include various data relating to the applications, such as the name, publisher, and other aspects of the application, and so forth, and may not include the application executable code, but may include a reference to a location where the executable code can be obtained. The search system 100 may then transmit the search results to the user device that transmitted the search query.

A user device 102 may display the search results to the user and allow the user to select one of the applications in the list in order to view information related to the application and/or download the application. The applications (e.g., the executable programs) listed in the search results sent to the user device 102 may be accessible from (e.g., downloaded from) systems different than the search system 100 in some examples. Put another way, the search system 100 may store data related to applications that are accessible in locations other than the search system 100. For example, the applications may be accessible from a software application marketplace 106 (hereinafter “application marketplace 106”). The application marketplace 106 may be a digital distribution platform configured to distribute the applications. Example application marketplaces include, but are not limited to, Google Play developed by Google Inc., the App Store developed by Apple Inc., and Windows Phone Store developed by Microsoft Corporation. Although a single application marketplace 106 is illustrated in FIG. 1, the techniques of the present disclosure may be applicable to environments including multiple application marketplaces, as described herein. Although the applications listed in the search results generated by the search system 100 may be accessed in locations other than the search system 100, it is contemplated that the search system 100 may include applications for download in some implementations.

The search system 100 includes an application data store 108 and an application search module 110. The application data store 108 includes a variety of different types of data related to different applications. The application data store 108 may include one or more databases, indices (e.g., inverted indices), files, or other data structures which may be used to implement the techniques of the present disclosure. As described herein, the data included in the application data store 108 may include descriptions of applications, statistics related to applications (e.g., application statistics and market-adjusted statistics), market-wide statistics, application scoring features, and other information. The application search module 110 receives a search query and generates search results based on the data included in the application data store 108.

The search system 100 includes a statistics module 112. The statistics module 112 retrieves statistics from the application marketplace 106 and the data sources 114. The statistics module 112 may store retrieved statistics in the application data store 108. The statistics module 112 may also process statistics that are retrieved or stored. For example, the statistics module 112 may generate the application statistics, market-wide statistics, and the market-adjusted statistics included in the application data store 108. The statistics module 112 may also generate application scoring features based on statistics. For example, the statistics module 112 may generate application scoring features based on market-adjusted statistics. The statistics module 112 may store the application scoring features in the application data store 108.

The search system 100 may communicate with the user devices 102, a partner computing system 116, the application marketplace 106, and the data sources 114 via the network 104. Examples of the user devices 102, the partner computing system 116, the data sources 114, the application marketplace 106, and the network 104 are now described in turn.

The example environment illustrated in FIG. 1 includes a plurality of user devices 102. An individual user device may also be referred to herein as a user device 102. User devices 102 can be any computing devices that are capable of providing search queries to the search system 100. User devices 102 may include, but are not limited to, smart phones, tablet computers, laptop computers, and desktop computers, as illustrated in FIG. 1. User devices 102 may also include other computing devices having other form factors, such as computing devices included in vehicles, gaming devices, televisions, or other appliances (e.g., networked home automation devices).

The user devices 102 may use a variety of different operating systems. In an example where a user device 102 is a mobile device, the user device 102 may run an operating system including, but not limited to, ANDROID, iOS developed by Apple Inc., or WINDOWS PHONE developed by Microsoft Corporation. In an example where a user device 102 is a laptop or desktop device, the user device 102 may run an operating system including, but not limited to, MICROSOFT WINDOWS, MAC OS, or Linux (e.g., RED HAT LINUX). User devices 102 may also access the search system 100 while running operating systems other than those operating systems described above, whether presently available or developed in the future.

User devices 102 can communicate with the search system 100 via the network 104. In some examples, a user device 102 may communicate with the search system 100 using an application installed on the user device 102. In general, a user device 102 may communicate with the search system 100 using any application that can transmit search queries to the search system 100. In some examples, a user device 102 may run an application that is dedicated to interfacing with the search system 100, such as an application dedicated to application searches. In some examples, a user device 102 may communicate with the search system 100 using a more general application, such as a web-browser application. The application run by a user device 102 to communicate with the search system 100 may display a search field on a graphical user interface (GUI) in which the user may enter search queries. The user may enter a search query using a touchscreen or physical keyboard, a speech-to-text program, or other form of user input.

A search query entered into a GUI on a user device 102 may include words, numbers, and/or symbols. In general, a search query may be a request for information retrieval (e.g., search results) from the search system 100. For example, a search query may be directed to retrieving a list of applications in examples where the search system 100 is configured to generate a list of applications as search results. A search query directed to retrieving a list of applications may indicate a user's desire to retrieve applications that have a functionality described by the search query.

A user device 102 may receive a set of search results from the search system 100 that are responsive to the search query transmitted to the search system 100. The user device 102 may be running an application including a GUI that displays the search results received from the search system 100. For example, the application used to transmit the search query to the search system 100 may also display the received search results to the user. As described above, the application that displays the received search results to the user may be dedicated to interfacing with the search system 100 in some examples. In other examples, the application may be a more general application, such as a web-browser application.

The GUI of the application running on the user device 102 may display the search results to the user in a variety of different ways, depending on what information is transmitted to the user device 102. In examples where the search results include a list of ranked applications, the search system 100 may transmit the list of applications to the user device 102. In this example, the GUI may display the search results to the user as a list of application names. In some examples, the search system 100, or other computing system, may transmit additional information to the user device 102 including, but not limited to, application ratings, application download numbers, application screenshots, and application descriptions. This additional information may be stored in the application data store 108 and transmitted by the search system 100 to the user device 102 in some examples. In examples where the user device 102 receives this additional information, the GUI may display this information along with the list of application names. In some examples, the GUI may display the search results as a list of applications ordered from the top of the screen to the bottom of the screen by descending result score. In some examples, the search results may be displayed under the search field in which the user entered the search query.

In some examples, user devices 102 may communicate with the search system 100 via the partner computing system 116. The partner computing system 116 may represent a computing system of a third party that may leverage the search functionality of the search system 100. The partner computing system 116 may belong to a company or organization other than that which operates the search system 100. Example third parties which may leverage the functionality of the search system 100 may include, but are not limited to, internet search providers and wireless communications service providers. The user devices 102 may send search queries to the search system 100 via the partner computing system 116. The user devices 102 may also receive search results from the search system 100 via the partner computing system 116. The partner computing system 116 may provide a user interface to the user devices 102 in some examples and/or modify the search experience provided on the user devices 102.

FIG. 1 shows a plurality of data sources 114-1, 114-2, 114-3, 114-4 (collectively “data sources 114”). The data sources 114 may be sources of data which the search system 100 may use to generate and update the application data store 108. For example, the search system 100 may generate new application records (e.g., application record 120 of FIG. 2B) and update existing application records based on data retrieved from the data sources 114. As described hereinafter, the statistics module 112 may generate statistics included in the application data store 108 based on data retrieved from data sources 114.

The data sources 114 may include a variety of different data providers. The data sources 114 may include data from application developers 114-1, such as application developers' websites. The data sources 114 may also include other websites, such as websites that include web logs 114-2 (i.e., blogs), application review websites 114-3, or other websites including data related to applications. Additionally, the data sources 114 may include social networking sites 114-4, such as “Facebook” (e.g., Facebook posts) and “Twitter” (e.g., text from tweets). Data sources 114 may also include additional types of data sources in addition to data sources 114-1, 114-2, 114-3, 114-4 described above. Different data sources may have their own content and update rate.

FIG. 1 shows an application marketplace 106. The application marketplace 106 may be another source of data which the search system 100 may use to generate and update the application data store 108. For example, the search system 100 may generate new application records and update existing application records based on data retrieved from the application marketplace 106. Although only one application marketplace 106 is illustrated in FIG. 1, the search system 100 may generate new application records and update existing application records based on data retrieved from multiple application marketplaces. Different application marketplaces may have their own content and update rate. As described herein, the statistics module 112 may generate statistics included in the application data store 108 based on data retrieved from one or more application marketplaces (e.g., application marketplace 106). In some implementations, the search system 100 may also include other modules (not illustrated) that generate new application records and update existing application records based on the data retrieved from data sources 114 and the application marketplace 106.

The search system 100 retrieves data from the application marketplace 106 and one or more of the data sources 114. The data retrieved from the application marketplace 106 and various data sources 114 can include any type of data related to applications. Examples of data related to applications include, but are not limited to, a name of an application, a description of an application, a substantive review of an application, a quality rating of an application, a developer name, an excerpt from a blog post about an application, a tweet about an application, and one or more images (e.g., icons and/or screenshots) associated with the application. In some examples, data retrieved from the application marketplace 106 and data sources 114 may include information regarding the functionalities of applications. The statistics module 112 may also retrieve statistical data related to applications. Statistical data may include any numerical data related to the application, such as a number of downloads, download rates (e.g., downloads per month), a number of reviews, and a number of ratings.

The search system 100 is configured to generate and update the data in the application data store 108 based on the data retrieved from the application marketplace 106 and data sources 114. For example, the search system 100 may use the retrieved data to update one or more databases, indices, files, or other data structures included in the application data store 108. As described herein, the application data store 108 may include a plurality of application records. The search system 100 may generate new application records and update existing application records based on the data retrieved from the application marketplace 106 and data sources 114. In some examples, some data included in the application data store 108 may be manually generated.

As described above, the user devices 102, the search system 100, the application marketplace 106, and the data sources 114 may be in communication with one another via the network 104. The network 104 may include various types of networks, such as a wide area network (WAN) and/or the Internet. Although the network 104 may represent a long range network (e.g., Internet or WAN), in some implementations, the network 104 may include a shorter range network, such as a local area network (LAN). In one embodiment, the network 104 uses standard communications technologies and/or protocols. Thus, the network 104 can include links using technologies such as Ethernet, Wireless Fidelity (WiFi) (e.g., 802.11), worldwide interoperability for microwave access (WiMAX), 3G, Long Term Evolution (LTE), digital subscriber line (DSL), asynchronous transfer mode (ATM), InfiniBand, PCI Express Advanced Switching, etc. Similarly, the networking protocols used on the network 104 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 104 can be represented using technologies and/or formats including the hypertext markup language (HTML), the extensible markup language (XML), etc. In addition, all or some of the links can be encrypted using conventional encryption technologies such as secure sockets layer (SSL), transport layer security (TLS), virtual private networks (VPNs), Internet Protocol security (IPsec), etc. In other examples, the network 104 can use custom and/or dedicated data communications technologies instead of, or in addition to, the ones described above.

FIG. 2A shows example data which may be stored in the application data store 108. FIG. 2B shows an example application record 120. The application record 120 may generally represent data stored in the application data store 108 that is related to an application. The application data store 108 may include data related to a plurality of applications. Accordingly, as illustrated in FIG. 2A, the application data store 108 includes a plurality of application records 122-1, 122-2, . . . , 122-N (collectively “application records 122”). Additionally, the application data store 108 includes market-wide statistics 124. The search system 100 (e.g., the statistics module 112) may generate the data included in the application data store 108.

The example application record 120 includes an application name 126, an application identifier 128 (hereinafter “application ID 128”), application attributes 130, application scoring features 132, application statistics 134, and market-adjusted statistics 136. The application data store 108 may include a plurality of application records having a similar structure as the application record 120. The application name 126 may be the name of the application represented by the data in the application record 120. Example application names may include “Google Maps”, “Facebook”, “Twitter”, “Microsoft Word”, or “Angry Birds”. The application ID 128 identifies the application record 120 amongst the other application records included in the application data store 108. For example, the application ID 128 may uniquely identify the application record 120. The application ID 128 may be a string of alphabetic, numeric, and/or symbolic characters (e.g., punctuation marks) that uniquely identify the application record 120 in which the application ID 128 is included.

The application attributes 130 may include a variety of different types of data which may be associated with the application represented by the application record 120. For example, the application attributes 130 may include structured, semi-structured, and/or unstructured data. The application attributes 130 may include information that is extracted or inferred from the application marketplace 106 and/or from the data sources 114. In some examples, the application attributes 130 may include data that is manually generated. The application attributes 130 may be updated so that up to date results can be provided in response to a user search query.

The application attributes 130 may include the name of the developer of the application, the publisher of the application, a category of the application (e.g., games), a description of the application (e.g., a developer's textual description), a version of the application, the operating system for the application, and the price of the application. The application attributes 130 may also indicate security or privacy data about the application, battery usage of the application, and bandwidth usage of the application. The application attributes 130 may also include information retrieved from websites such as reviews associated with the application, articles associated with the application (e.g., wiki articles), or other information. The application attributes 130 may also include digital media related to the application, such as images (e.g., icons and/or screenshots).

The application record 120 may include application scoring features 132. The application scoring features 132 may include any of the application attributes included in the application record or any additional parameters related to the application, such as data indicating the popularity of an application (e.g., number of downloads) and the ratings (e.g., number of stars) associated with an application. The search system 100 may use the application scoring features 132 to generate result scores for the application associated with the application record 120. As described herein, the statistics module 112 may generate some of the application scoring features 132 using market-adjusted statistics. In some implementations, application scoring features may not be stored in the application data store 108. Instead, application scoring features may be generated at search time based on statistics included in the application data store 108. For example, the application set processing module 154 may generate application scoring features at search time based on market-adjusted statistics 136, market-wide statistics 124, application statistics 134, or other data stored in the application record 120.

The application record 120 includes application statistics 134. The application statistics 134 may refer to numerical data related to the application. For example, the application statistics 134 may include, but are not limited to, application download statistics, application ratings statistics, and application review statistics. The application download statistics may include any numerical data related to downloads, such as a number of downloads over time (e.g., a download vs. time curve) and/or a download rate (e.g., downloads per month) over time, for example. The application ratings statistics may include numerical data related to ratings, such as a number of ratings over time. The application review statistics may include numerical data related to reviews, such as a number of reviews over time. The application statistics 134 may include additional types of statistics not illustrated in FIG. 2B, such as a number of user-views of the application in the application marketplace 106 over time.

The application statistics 134 may also include the rate of change of statistics over time. For example, the application statistics 134 may include the first derivative and/or the second derivative of a statistic. In a further example, the application download statistics may include the first derivative of the number of downloads over time and/or the first derivative of the download rate over time. In another example, the application download statistics may include the second derivative of the number of downloads over time and/or the second derivative of the download rate over time. Similarly, the application ratings statistics and the application review statistics may include the derivatives (e.g., first and/or second) of the number of ratings and the number of reviews, respectively.

The statistics module 112 may extract or infer the application statistics 134 from the application marketplace 106 and/or the data sources 114. For example, statistics module 112 may retrieve statistics that are reported by the application marketplace 106 and/or data sources 114. The statistics module 112 may then generate application statistics 134 based on the retrieved statistics. The statistics module 112 may add to, or modify, the application statistics 134 based on newly retrieved data from the application marketplace 106 and the data sources 114.

In examples where one or more application marketplaces report download statistics for an application, the statistics module 112 may retrieve reported download statistics for an application by retrieving download statistics from the one or more application marketplaces. Similarly, the statistics module 112 may retrieve other application statistics, such as rating and review statistics from the one or more application marketplaces that report such statistics. In some implementations, the application record 120 may indicate which of the one or more application marketplaces reported the statistics. For example, if two application marketplaces include the same application, the application record for the application may include different sets of download statistics. In this example, the application record may indicate which application marketplace is associated with each set of application statistics. Additionally, in this example, the application record may include a set of application statistics that indicates the total downloads (e.g., the sum of the downloads) from both application marketplaces.

Each application record may include multiple different sets of application statistics. A single set of application statistics may refer to a set of numerical data over time. For example, a single set of application statistics may include a set of data points (e.g., download numbers) that occur at different times in the application's life. A set of application statistics may start at a time when the application was introduced to the application marketplace 106. Put another way, the data points in a set of application statistics may date back to the time when the application was made available for download on the application marketplace 106. Accordingly, a set of application statistics included in an application record may include data points for the application over time beginning from when the application was introduced to the application marketplace 106 up until the present day.

An example set of application statistics may include a set of download statistics over time. Such a set of download statistics may include data points over time that indicate the number of times the application was downloaded. Another example set of application statistics may include a set of download rate statistics over time (e.g., downloads per month). Such a set of download rate statistics may include data points over time that indicate the download rate of the application at different points in time. Other example sets of application statistics may include a set of ratings statistics over time and a set of review statistics over time. Other example sets of application statistics may include events associated with an application, such as a number of times the application was updated, patched, changed ownership, or was included in marketing campaigns. In some examples, a set of application statistics may be based on multiple different types of application statistics. For example, a set of application statistics may include data points indicating the number of ratings divided by the number of downloads (e.g., ratings per download).

As described above, each application record may include multiple different sets of application statistics. In some implementations, different application records may include the same types of application statistics. For example, each application record may include a set of download statistics, a set of download rate statistics, a set of ratings statistics, and a set of review statistics. In other implementations, different application records may include additional or alternative sets of application statistics since different types of statistics may be available for different applications, depending on which application marketplaces include the applications and based on which data sources include data related to the applications.

The time between data points in a set of application statistics may vary depending on a variety of different factors. The time between data points may vary based on how often the application marketplace 106 and the data sources 114 are updated. For example, different application marketplaces and data sources including application statistics may be updated at different rates. In some examples, data points may be updated in real-time, on a daily basis, on a weekly basis, on a monthly basis, or at another rate. The time between data points may also vary depending on how often the statistics module 112 retrieves statistics from the application marketplace 106 and data sources 114. The time periods between data points may be similar (e.g., equal) in some examples, so that each data point in a set of application statistics is separated from adjacent data points by the same amount of time. In other examples, the time periods between data points may vary.

In some implementations, the data points included in a set of application statistics may be directly retrieved from one or more application marketplaces. For example, the search system may directly retrieve the number of downloads of an application from the application marketplace 106. In some implementations, the statistics module 112 may generate data points based on retrieved data. For example, the statistics module 112 may generate data points in a set of application statistics by interpolating between retrieved data points.

The application data store 108 includes one or more sets of market-wide statistics. Market-wide statistics may be an aggregate of application statistics for a plurality of different applications. In one sense, market-wide statistics may represent the size of a market over time, along with the changes in the size of the market over time. An example set of market-wide statistics may be a set of market-wide download statistics. In one example, a set of market-wide download statistics may be the sum of all of the application downloads from the application marketplace 106 over time. In this example, the data points representing the number of downloads in the set of market-wide download statistics may increase in value over time as users continue to download more applications from the application marketplace 106. Another example set of market-wide download statistics may be the sum of all of the download rates (e.g., downloads per month) from the application marketplace 106 over time. Another example set of market-wide statistics may be the average rate of downloads per unique user per month, which may indicate the tendency of the market's users to download new applications in general.

The statistics module 112 may define the market represented by a set of market-wide statistics by selecting which statistics are included in the set of market-wide statistics. In some implementations, the statistics module 112 may generate market-wide statistics based on application statistics included in the application data store 108. For example, the statistics module 112 may define a set of market-wide download statistics as the sum of download statistics from each of the application records in the application data store 108. In a similar example, the statistics module 112 may generate market-wide ratings statistics as the sum of the ratings statistics from each of the application records in the application data store 108.

In some implementations, the statistics module 112 may define a market such that the market-wide statistics correspond to a single application marketplace. For example, the market-wide statistics may be based on application statistics aggregated from only a single application marketplace. In these implementations, a first set of market-wide statistics may include the total number of downloads on the single application marketplace over time. The first set of market-wide statistics may include data points having values that increase over time since users may continue to download applications from the application marketplace. A second set of market-wide statistics may be the total number of ratings on the single application marketplace over time.

The statistics module 112 may also define a market such that the market-wide statistics correspond to a combination of multiple application marketplaces. For example, the market-wide statistics may be based on application statistics aggregated from multiple application marketplaces. In these implementations, an example set of market-wide download statistics may include the total number of downloads from the multiple application marketplaces over time.

In some implementations, the statistics module 112 may define a market such that the market-wide statistics correspond to a category of an application. For example, the market-wide statistics may be based on application statistics aggregated from applications included in a single category, such as games, productivity, shopping, education, or other category. In these implementations, a first set of market-wide statistics may be the total number of downloads for the games category of application on the application marketplace 106 over time. A second set of market-wide statistics may be the total number of downloads for the productivity category on the application marketplace 106 over time.

As described above, the application marketplace 106 or other data source 114 may report statistical values related to applications, such as the numbers of downloads, ratings, and reviews. In some implementations, the statistics module 112 may set the data points of the market-wide statistics to values that are equal to those values reported by the application marketplace 106. For example, if the application marketplace 106 reports the total number of downloads in the application marketplace 106 for all applications available in the application marketplace 106, the statistics module 112 may set the market-wide download statistics in the application data store 108 equal the total number of downloads reported by the application marketplace 106. In another example, if the application marketplace 106 reports the total number of downloads for a single application in the application marketplace 106, the statistics module 112 may set the application download statistics to the value reported by the application marketplace 106.

Although the market-wide statistics 124 included in the application data store 108 may be equal to those reported by the application marketplace 106 and/or data sources 114 in some examples, in other examples, the market-wide statistics 124 in the application data store 108 may differ from those reported. For example, the statistics reported by the application marketplace 106 may not be equivalent to the market-wide statistics included in the application data store 108 in examples where the statistics module 112 defines the market-wide statistics 124 based on application statistics included in the application data store 108 rather than using the statistics reported by the application marketplace 106. In one example, the statistics module 112 may define a set of market-wide download statistics as the sum of the application download statistics included in the application data store 108. In this example, the market-wide download statistics in the application data store 108 may reflect a lower number of downloads over time relative to the download numbers reported by the application marketplace 106 because the application data store 108 may not include application statistics for all of the applications included in the application marketplace 106.

Other scenarios may exist in which market-wide statistics 124 included in the application data store 108 differ from statistics reported by the application marketplace 106. For example, the market-wide statistics 124 included in the application data store 108 may differ from statistics reported by the application marketplace 106 in scenarios where the statistics module 112 generates the market-wide statistics using any of data sources 114, which may report different statistics than the application marketplace 106.

In some examples, market-wide statistics 124 may be derived from sources other than application statistics. Examples of such market-wide statistics include, but are not limited to, a total number of applications available from the application marketplace 106 and a number of users of the application marketplace 106. These market-wide statistics may be retrieved from the application marketplace 106 or data sources 114 (e.g., a website).

Although a set of market-wide statistics may be defined by a single type of statistic, such as downloads or ratings, in other implementations, a set of market-wide statistics may be defined by more than one type of statistic. For example, a set of market-wide statistics may be defined as the total number of downloads in the application marketplace 106 divided by the total number of ratings in the application marketplace 106.

The application records 122 in the application data store 108 include one or more sets of market-adjusted statistics. The statistics module 112 generates the market-adjusted statistics included in the application records. The statistics module 112 generates market-adjusted statistics for an application based on the application statistics associated with the application and market-wide statistics. For example, the statistics module 112 may generate market-adjusted statistics for an application by adjusting the application statistics by the market-wide statistics. In some examples, the statistics module 112 may generate market-adjusted statistics for an application by normalizing (e.g., dividing) the application statistics by the market-wide statistics. Although application records may include the market-adjusted statistics, in other implementations, the statistics module 112 may generate market-adjusted statistics based on application statistics and market-wide statistics at search time (e.g., in response to receiving the search query).

As described above, the statistics module 112 may determine market-adjusted statistics by normalizing application statistics with market-wide statistics. For example, the statistics module 112 may divide the application statistics by the market-wide statistics to generate the market-adjusted statistics. In examples where the application statistics and the market-wide statistics include discrete data points over time, the statistics module 112 may divide data points of the application statistics by data points in the market-wide statistics at similar points in time. In examples where data points of the application statistics and data points of the market-wide statistics do not correspond in time, the statistics module 112 may interpolate new data points to use in the calculation.

Market-adjusted statistics may include a plurality of data points over time, similar to application statistics and market-wide statistics. Accordingly, market-adjusted statistics may be visualized as a graph of statistical data points over time (e.g., FIG. 3). A set of market-adjusted statistics for an application may start at a time when the application was introduced for download from the application marketplace 106. The set of market-adjusted statistics may extend from the time when the application was introduced until the present day.

The statistics module 112 may generate market-adjusted statistics by normalizing (e.g., dividing) any type of application statistics by any type of market-wide statistics. For example, the statistics module 112 may generate market-adjusted statistics by dividing any type of application statistics described herein by any type of market-wide statistics described herein. In some examples, the statistics module 112 may generate market-adjusted statistics based on application statistics and market-wide statistics having the same type of statistics. For example, the statistics module 112 may generate market-adjusted download statistics by normalizing application download statistics by market-wide download statistics. Similarly, the statistics module 112 may generate market-adjusted ratings statistics by normalizing application ratings statistics by market-wide ratings statistics. As another example, the statistics module 112 may generate market-adjusted review statistics by normalizing application review statistics by market-wide review statistics. In other examples, the statistics module 112 may generate market-adjusted statistics based on application statistics and market-wide statistics having different types of statistics. For example, the statistics module 112 may generate a set of market-adjusted statistics by normalizing a set of application download statistics by market-wide ratings statistics.

Referring now to FIG. 3, the graph shows download statistics versus time. Example market-wide download statistics 140, application download statistics 142, and market-adjusted download statistics 144 are illustrated. The solid lines for market-wide download statistics 140 and the application download statistics 142 may represent a number of downloads versus time. The broken line for market-adjusted download statistics 144 may represent the ratio of application download statistics 142 to market-wide download statistics 140, which may be a dimensionless quantity.

Although the statistics curves 140, 142, 144 are illustrated as continuous in FIG. 3, the statistics curves 140, 142, 144 are comprised of data points over time. The graph of FIG. 3 is meant to show example qualitative properties of market-wide statistics, application statistics, and market-adjusted statistics. Accordingly, the curves 140, 142, 144 are meant to illustrate concepts described herein, and may not be drawn to scale (similar to FIGS. 7-8).

The Y-axis indicates a number of downloads. The Y-axis includes a discontinuity, which is indicated at 146. The discontinuity illustrates the difference in magnitude of the download numbers associated with market-wide download statistics 140 and the application download statistics 142. For example, the market-wide download statistics 140 may represent download numbers in the billions, while the application download statistics 142 (e.g., downloads for an app) may represent download numbers on a smaller scale. In some examples, application download statistics 142 could represent application downloads in the hundreds. In other examples, application download statistics 142 could represent application downloads in the thousands or tens of thousands. In still other examples, application download statistics 142 may represent application downloads in the millions.

The market-wide download statistics 140 may represent the number of application downloads in the application marketplace 106. Note that the number of downloads represented by the market-wide download statistics 140 monotonically increases. The increase in the market-wide download statistics 140 may be a combination of an increase in the number of users that are downloading from the application marketplace 106 and/or an increase in the number of downloads per user of the application marketplace 106.

The application download statistics 142 may represent the number of times an application was downloaded from the application marketplace 106. Note that the number of downloads represented by the application download statistics 142 has monotonically increased and flattened off over time. The shape of the application download statistics 142 indicates that the application was initially downloaded at a greater rate. As described above, the application download statistics 142 may be on the order of hundreds, thousands, or millions of downloads, depending on the popularity of the application.

The market-adjusted download statistics 144 are determined based on the application download statistics 142 and the market-wide download statistics 140. For example, the market-adjusted download statistics 144 may represent the application download statistics 142 normalized by (e.g., divided by) the market-wide download statistics 140. The market-adjusted download statistics 144 may not be drawn to scale relative to the application download statistics 144. For example, since the market-adjusted download statistics 144 may be the resulting quotient of the application download statistics 142 divided by the market-wide download statistics 140, the curve representing the market-adjusted download statistics 144 may tend to be much smaller than the curve for the application download statistics 142. Instead, the curve for the market-adjusted download statistics 144 is meant to illustrate how market-adjusted download statistics may behave for an application. Note that initially the application download statistics 142 increased in value, as indicated at 148. In this example, the value of the market-adjusted download statistics 144 also increased. However, over time, the value of the application download statistics 142 tends to level off. During the time the value of the application download statistics 142 leveled off, the market-wide download statistics 140 continued to increase. Accordingly, the value of the market-adjusted download statistics 144 tended to decrease over time.

The statistics module 112 may generate application scoring features (e.g., application scoring features 132) based on market-adjusted statistics. The search system 100 may use the application scoring features to generate results scores for search results. Accordingly, the search system 100 may generate result scores based on market-adjusted statistics. The search system 100 may also generate result scores based on other scoring features, such as query scoring features, application-query scoring features, and application scoring features derived from data other than market-adjusted statistics.

In some examples, an application scoring feature may be a data point selected from market-adjusted statistics. For example, an application scoring feature may be the market-adjusted download number for an application at a point in time three months after the application was introduced to the application marketplace 106. Another example application scoring feature from market-adjusted statistics may be the maximum market-adjusted download statistic. In this example, the statistics module 112 may determine the maximum value of a data point in the market-adjusted statistics of an application. The statistics module 112 may then store the maximum value (e.g., the maximum market-adjusted download value) in the application record as an application scoring feature. The search system 100 may use the determined maximum value as an application scoring feature to generate a result score for the application.

Instead of using a data point from market-adjusted statistics as an application scoring feature, in other implementations, the statistics module 112 may perform additional processing on market-adjusted statistics in order to generate an application scoring feature. In some examples, the statistics module 112 may use multiple market-adjusted data points to generate a single application scoring feature. For example, the statistics module 112 may generate an application scoring feature that is a sum of multiple data points of market-adjusted statistics. An example application scoring feature of this type may be the sum of the total market-adjusted download statistics for the first 3 months after an application was introduced to the application marketplace 106. Put another way, this application scoring feature may be thought of as the total area under the curve of the market-adjusted download statistics for the first 3 months after the application's introduction.

Another example application scoring feature based on multiple data points may include any application scoring feature based on the change in value of market-adjusted statistics over time. An example application scoring feature of this type may be the maximum change (e.g., first derivative) in market-adjusted downloads during the lifetime of an application. Another example application scoring feature of this type may be the change (e.g., first derivative) in market-adjusted downloads during a specified period of time, such as 6 months to 1 year after introduction of an application. Another example application scoring feature of this type may be application scoring features based on the second derivative of market-adjusted statistics, such as a maximum second derivative value of market-adjusted statistics over the lifetime of an application.

Another example application scoring feature may be based on a comparison of market-adjusted statistics of an application to a threshold value. The threshold value may be based on market-adjusted statistics (e.g., downloads) for a plurality of other applications. For example, the threshold value may be the average market-adjusted value for applications at 3 months of age. In this example, the statistics module 112 may generate the threshold value by determining an average market-adjusted value at 3 months of age for a plurality of applications. The statistics module 112 may then determine an application scoring feature for an application by comparing the market-adjusted value at 3 months of age for the application to the threshold value. The application scoring feature may be a binary number that indicates whether the market-adjusted value for the application is greater than or less than the threshold value. The application scoring feature may also be a value that indicates how much greater or less the market-adjusted value was than the threshold value. Although a threshold value based on the average market-adjusted value for applications at 3 months is described above, the statistics module 112 may generate other types of threshold values based on market-adjusted statistics for a plurality of applications. Accordingly, the statistics module 112 may generate application scoring features based on comparisons of market-adjusted statistics to other types of threshold values.

FIG. 4 shows an example method 200 for generating application scoring features based on market-adjusted statistics. Initially, the statistics module 112 generates application statistics in block 202. For example, the statistics module 112 may retrieve or infer application statistics reported by one or more application marketplaces (e.g., application marketplace 106) and/or the data sources 114. The statistics module 112 may store the generated application statistics in the application data store 108. For example, the statistics module 112 may store one or more sets of application statistics in an application record.

In block 204, the statistics module 112 generates market-wide statistics. In some examples, the statistics module 112 may generate market-wide statistics based on application statistics included in a plurality of application records in the application data store 108. In some examples, the statistics module 112 may generate market-wide statistics by retrieving statistics reported by one or more application marketplaces (e.g., application marketplace 106) and data sources 114. The statistics module 112 may store one or more sets of market-wide statistics in the application data store 108.

In block 206, the statistics module 112 generates market-adjusted statistics based on application statistics and market-wide statistics. The statistics module 112 may generate market-adjusted statistics for an application by normalizing (e.g., dividing) application statistics by market-wide statistics. In some examples, the statistics module 112 may store one or more sets of market-adjusted statistics for an application in the application data store 108 (e.g., in application records). Although the market-adjusted statistics may be stored in the application data store 108, in other examples, the statistics module 112 may determine the market-adjusted statistics at search time in response to a search query.

In block 208, the statistics module 112 generates one or more application scoring features based on market-adjusted statistics. For example, the statistics module 112 may generate one or more application scoring features based on data point(s) retrieved from market-adjusted statistics. In some examples, the statistics module 112 may store the one or more application scoring features for an application in the application data store 108 (e.g., in an application record). Although the application scoring features may be stored in the application data store 108, in other examples, the application scoring features may be generated at search time response to a search query.

FIG. 5 shows an example application search module 110 which may be included in the search system 100. The application search module 110 includes a query analysis module 150, an application set generation module 152 (hereinafter “set generation module 152”), and an application set processing module 154 (hereinafter “set processing module 154”). The query analysis module 150 analyzes a received search query 156. The set generation module 152 identifies a set of applications (e.g., application records) based on the received search query 156. The identified set of applications may be referred to herein as a “consideration set.” The set processing module 154 processes (e.g., scores) the consideration set to generate a set of search results 158 that may include a list of applications along with corresponding result scores indicating the relative rank of each application amongst the other applications in list.

The search query 156 may be a search query entered by a user on a user device 102. The search query 156 includes text, numbers, and/or symbols (e.g., punctuation) entered into the user device 102 by the user. For example, the user may have entered the search query 156 into a search field (e.g., a search box) of an application running on the user device 102 using a touchscreen keypad, a mechanical keypad, and/or via speech recognition. The search results 158 generated by the application search module 110 may be transmitted back to the user device 102 that generated the search query 156.

Although the search system 100 (e.g., the query analysis module 150) is illustrated and described herein as receiving a search query 156 that includes text, it is contemplated that the search system 100 (e.g., the query analysis module 150) may receive additional data along with the search query 156. The search query 156 and the additional data along with the search query 156 may be referred to as a query wrapper. In some examples, the query wrapper may include contextual information associated with the search query 156, such as platform constraint information (e.g., operating system version, device type, browser version), geo-location preferences, partner specific information (e.g., which services are being used to access the search system 100), and other information. A user device 102 may generate and transmit the additional data included in a query wrapper at the time the user device 102 transmits the search query 156.

The query analysis module 150 receives the search query 156 from a user device 102. The query analysis module 150 may perform various analysis operations on the received search query 156. For example, analysis operations performed by the query analysis module 150 may include, but are not limited to, tokenization of the query, filtering of the query, stemming, synonymization, and stop word removal.

The set generation module 152 identifies a set of applications (i.e., the consideration set) based on the search query 156. In some examples, the set generation module 152 may identify the set of applications by identifying application records based on matches between terms of the search query 156 and terms in the application records. For example, the set generation module 152 may identify a set of applications in the application data store 108 based on matches between tokens generated by the query analysis module 150 and words included in the application records. The consideration set of applications may be a list of application records in some examples. For example, the consideration set may be a list of application IDs and/or a list of application names.

The set processing module 154 performs a variety of different processing operations on the consideration set to generate a set of search results 158 that includes a list of applications. In some implementations, the set processing module 154 may generate a result score for each of the applications included in the consideration set in order to generate the set of search results 158. In these implementations, the set of search results 158 may include a list of applications (e.g., application IDs and/or application names), each of which is associated with a corresponding result score. In some examples, the search results 158 may include all of the applications from the consideration set. In other examples, the search results 158 may include a subset of the consideration set. For example, the subset may be those applications having the largest result scores.

The information conveyed by the search results 158 may depend on how the result scores are calculated by the set processing module 154. For example, the result scores may indicate the relevance of an application to the search query, the popularity of an application in the marketplace, the quality of an application, or other properties of the application, depending on what parameters the set processing module 154 uses to score the applications.

The set processing module 154 may generate result scores for applications in a variety of different ways. In general, the set processing module 154 may generate a result score for an application based on one or more scoring features. The scoring features may be associated with the application and/or the search query 156.

An application scoring feature may include any data associated with an application. For example, application scoring features may include any of the application attributes included in the application record or any additional parameters related to the application, such as data indicating the popularity of an application (e.g., number of downloads) and the ratings (e.g., number of stars) associated with an application. As described above, one or more application scoring features may be based on market-adjusted statistics. In one example, an application scoring feature may be a data point selected from market-adjusted statistics. In another example, an application scoring feature may be based on multiple market-adjusted data points. For example, an application scoring feature may be based on a sum of multiple data points, or a derivative (e.g., first or second) based on multiple data points. Another example application scoring feature may be based on a comparison of market-adjusted statistics of an application to a threshold value.

A query scoring feature may include any data associated with the search query 156. For example, query scoring features may include, but are not limited to, a number of words in the query, the popularity of the query, and the expected frequency of the words in the query. An application-query scoring feature may include any data which may be generated based on data associated with both the application and the search query 156 (e.g., the query that resulted in identification of the application record by the set generation module 152). For example, application-query scoring features may include, but are not limited to, parameters that indicate how well the terms of the query match the terms of the identified application record. The set processing module 154 may generate the query scoring features and/or the application-query scoring features. The set processing module 154 may generate a result score for an application based on at least one of the application scoring features, the query scoring features, and the application-query scoring features.

The set processing module 154 may determine a result score based on one or more of the scoring features listed herein and/or additional scoring features not explicitly listed. In some examples, the set processing module 154 may include a function that receives one or more of the scoring features as input. For example, the function may incorporate any scoring features based on market-adjusted statistics. The function may also be based on scoring features that incorporate a number of downloads of the application, term frequency-inverse document frequency (TFIDF) scoring, text matches between search query terms and application title, and the number of words in the description of the application, for example. Although an example function may include the above listed features, other functions incorporating different features may be used by the set processing module 154.

In some examples, the set processing module 154 may include one or more machine learned models (e.g., a supervised learning model) configured to receive one or more scoring features, such as application scoring features derived from market-adjusted statistics. The one or more machine learned models may generate result scores based on at least one of the application scoring features, the query scoring features, and the application-query scoring features. For example, the set processing module 154 may pair the search query 156 with each application and calculate a vector of features for each (query, application) pair. The vector of features may include application scoring features, query scoring features, and application-query scoring features. The set processing module 154 may then input the vector of features into a machine-learned regression model to calculate a result score that may be used to rank the application in the search results 158 for the search query 156. In some examples, the set processing module 154 may input the vector of features along with a corresponding set of human curated scores into a machine-learned regression model to calculate a result score.

In some examples, the machine-learned regression model may include a set of decision trees (e.g., gradient boosted decision trees). In another example, the machine-learned regression model may include a logistic probability formula. In some examples, the machine learned task can be framed as a semi-supervised learning task, where a minority of the training data is labeled with human curated scores and the rest are used without human labels.

The results scores may be used in a variety of different ways. In some examples, the result scores may be used to rank the applications in a list of results that is presented on a user device 102. In these examples, a larger result score may indicate that the application is more relevant to a user than an application having a smaller result score. In examples where the search results 158 are displayed as a list on a user device 102, the applications associated with larger result scores may be listed nearer to the top of the results list (e.g., near to the top of the screen). In these examples, applications having lower result scores may be located farther down the list (e.g., off screen) and may be accessed by a user scrolling down the screen of the user device 102.

In some implementations, the set of search results 158 may be transmitted to a user device 102 that generated the search query 156 upon which the search results 158 are based. The search results 158 may be formatted on a user device 102 as a list of applications matching the search query 156. The search results 158 may include any suitable information corresponding to the various applications. For example, the search results 158 provided by the search system 100 to a user device 102 may be formatted as a list of applications, including, for example, a name of the application, an image associated with the application (e.g., a logo, a screenshot, and/or a video), a link to download the application, a description and rating of the application, and/or other information.

Although the search system 100 may transmit the search results 158 to a user device 102 in some implementations, in other implementations, the search system 100 may use the search results 158 in a different manner. For example, the search system 100 may use the search results 158 as a basis for generating advertisements for the user. It is also contemplated that the search system 100 may select which of the search results 158 to transmit to a user device 102 in some examples. For example, the search system 100 may only transmit the highest ranked search result to a user device 102 in some examples.

FIG. 6 shows an example method 300 for performing a search based on a received search query. The method 300 is described with reference to the application search module 110 of FIG. 5. In block 302, the query analysis module 150 receives a search query 156 that was generated by a user device 102. In block 304, the query analysis module 150 analyzes the search query 156. In block 306, the set generation module 152 identifies a consideration set of applications (e.g., a set of application records) based on the search query 156 (e.g., based on output from the query analysis module 150).

In block 308, the set processing module 154 generates result scores for each application in the consideration set based on scoring features, such as query scoring features, application-query scoring features, and application scoring features. One or more of the application scoring features may be derived from market-adjusted statistics. In block 310, the set processing module 154 generates a set of search results 158. The search results 158 may include a list of applications and associated result scores. The search system 100 may then transmit the search results 158 to a user device 102 in some examples.

FIGS. 7-8 show two example scenarios in which using application scoring features derived from market-adjusted statistics may yield additional information which may be relevant to generating search results. FIGS. 7-8 show graphs of application download statistics versus time for applications that were introduced to the application marketplace 106 at different times. Although the application statistics curves are illustrated as continuous in FIGS. 7-8, the application statistics curves are comprised of data points over time. The Y-axis of FIGS. 7-8 indicate a number of downloads. The Y-axis of FIGS. 7-8 include discontinuities, which are indicated at 160, 162. The discontinuities 160, 162 illustrate the difference in magnitude of the download numbers associated with market-wide download statistics and the application download statistics, as described above with respect to FIG. 3.

Referring now to FIG. 7, example market-wide download statistics 164, application A download statistics 166, and application B download statistics 168 are illustrated. The market-wide download statistics 164 may represent the number of application downloads in the application marketplace 106. The application A download statistics 166 and the application B download statistics 168 represent the number of times application A and application B were downloaded from the application marketplace 106, respectively.

FIG. 7 illustrates an example of how older applications may tend to accumulate more statistics (e.g., downloads) than newer applications. In FIG. 7, application A was introduced to the application marketplace 106 at an earlier time than application B. Accordingly, application A has had more time to gain popularity and accumulate statistics than application B. Application B, which was introduced later, has not yet achieved number of downloads equal to that achieved by application A. Specifically, in the example curves of FIG. 7, application B has not achieved a greater number of downloads than application A at any point in time since application B was introduced.

Since the download statistics for application A are greater than application B while application B has been available, it would appear that application A may be a more desirable search result based on download statistics. Thus, generating search results based on application download statistics alone may tend to favor older applications which have had more time than newer applications to accumulate statistics, as illustrated in FIG. 7. Favoring older applications in this manner may tend to prevent newer applications from appearing as top search results.

Scoring applications using market-adjusted statistics according to the present disclosure may put applications of different ages on a similar footing for scoring purposes. One technique for scoring applications of different ages is using application scoring features that key in on how an application performed in the market at a selected age. The age of an application may refer to the amount of time the application has been available on the application marketplace 106. For example, an application scoring feature of this type may be the number of market-adjusted statistics for an application at a selected age. In this example, an application scoring feature may be the number of market-adjusted downloads for an application at a selected age. For example, the application scoring feature may be the number of market-adjusted downloads at 3 months after introduction of the application to the application marketplace 106. As another example, an application scoring feature may be the number of market-adjusted statistics accumulated by a selected age. For example, the application scoring feature may be the number of market-adjusted downloads for an application by a selected age, such as the total number of market-adjusted downloads by 5 months after introduction of the application to the application marketplace 106.

Another example application scoring feature may be a value (e.g., a binary value) indicating whether the application has reached a threshold number of market-adjusted statistics by a selected age. For example, an application scoring statistic may be a binary value indicating whether the application has reached a threshold number of market-adjusted downloads by 5 months after introduction to the application marketplace 106. The threshold number may be a performance indicator which may be based on how other applications have performed in the past (e.g., an average number of market-adjusted downloads). In some examples, an application scoring feature may be a value (e.g., decimal value) indicating how much the application has exceeded or fell short of a threshold number of market-adjusted statistics by a selected age.

Implementation of some application scoring features associated with a selected age of an application is now described with reference to application A and application B of FIG. 7. In FIG. 7, a time period “T” is illustrated at 170 and 172. The time period T may illustrate an amount of time in months, such as 1 month, 3 months, 12 months, or other time period. The time period “T” at 170 begins when application A is introduced to the application marketplace and ends at the time when application A is T months old, indicated at 174. The time period “T” at 172 begins when application B is introduced to the application marketplace 106 and ends at the time when application B is T months old, indicated at 176.

An example scoring feature which may be used for application A and application B is the number of market-adjusted download statistics when an application is T months old. In this example, the application scoring feature for application A would be the application A download statistics 166 indicated at time 174 divided by the market-wide download statistics 164 at that time. Similarly, the application scoring feature for application B would be the application B download statistics 168 indicated at time 176 divided by the market-wide download statistics 164 at that time.

It is clear from FIG. 7 that application B has a greater number of downloads at T months of age than application A had at T months of age. However, application A and application B were accumulating download statistics under different market conditions. For example, the market-wide download statistics 164 were less during the time application A was accumulating downloads. Accordingly, each download of application A during time T 170 may have more significance than a download that occurred during time T 172.

Using an application scoring feature derived from market-adjusted statistics allows the search system 100 to take into account the changes in the significance of application statistics over time. For example, using the number of market-adjusted download statistics for application A and application B at a time when the applications are T months old may allow the search system 100 to take into account the significance of application statistics at different times. The application B download statistics 168 at time 176 are substantially greater than the application A download statistics at time 174. The market-wide download statistics 164 did not substantially increased from time 174 to time 176. Accordingly, the market-adjusted download statistics for application B at time 176 may be greater than the market-adjusted download statistics for application A at time T 174. Under these assumptions, an application scoring feature that is equal to, or derived from, the number of market-adjusted download statistics when an application is T months old may be a scoring feature that could favor recently trending application B over application A. Using such application scoring features may allow a level comparison of different applications and may allow the newly rising application B to be scored higher than application A, even though application B has not had the same amount of time to accumulate download statistics. Accordingly, using application scoring features derived from market-adjusted statistics may help identify newer applications and place the newer applications higher in the search results, which may help users find newer applications during a search.

FIG. 8 shows another example in which market-adjusted statistics yield additional information. FIG. 8 illustrates an example of a newer application which has accumulated more statistics than an older application at the present day. In FIG. 8, although application C was introduced to the application marketplace 106 at an earlier time than application D, application D managed to accumulate a greater number of downloads than application C by present day. As illustrated, application D download statistics 180 overtook application C download statistics 182 at 184.

Since the download statistics for application D are greater than application C at the present time, it would appear that application D may be a more desirable search result based on current download statistics. Although application D may appear to be a better search result than application A at the present time based on downloads, application scoring features derived from market-adjusted statistics may be used to yield additional information about application C which may indicate that application C is a better search result than application D in some examples.

An example application scoring feature which may yield additional information about application C may be the number of market-adjusted statistics for an application at a selected age, similar to that described with respect to FIG. 7. For example, an application scoring feature that is equal to, or derived from, the number of market-adjusted downloads for an application at T months of age may yield additional information about application C that may be useful in generating search results. Another application scoring feature may be the number of market-adjusted statistics accumulated by a selected age (e.g., by T months).

Implementation of some application scoring features is now described with reference to application C and application D of FIG. 8. In FIG. 8, a time period “T” is illustrated at 186 and 188. The time period T may illustrate an amount of time in months, such as 1 month, 3 months, 12 months, or other time period. The time period “T” at 186 begins when application C is introduced to the application marketplace 106 and ends at the time when application C is T months old, indicated at 190. The time period “T” at 188 begins when application D is introduced to the application marketplace 106 and ends at the time when application D is T months old, indicated at 192.

An example scoring feature which may be used for application C and application D is the number of market-adjusted download statistics when an application is T months old. In this example, the application scoring feature for application C would be the application C download statistics 182 indicated at time 190 divided by the market-wide download statistics 194 at that time. Similarly, the application scoring feature for application D would be the application D download statistics 180 indicated at time 192 divided by the market-wide download statistics 194 at that time.

Although application D had slightly more downloads at time 192 than application C had at time 190, the market-adjusted download statistics at time 190 for application C are likely greater than the market-adjusted download statistics at time 192 for application D. This is because the number of application downloads for application C and application D are similar at T months of age. However, the market-wide download statistics 194 were greater during the time application D was introduced than was the case when application C was introduced. Accordingly, an application scoring feature based on the market-adjusted download statistics for an application at T months of age may favor application C in the search results.

A maximum historical number of market-adjusted statistics may also help the older application in this case, as described hereinafter. Application C and application D have very similar download statistics at the present day. Additionally, download statistics for application C leveled off prior to the introduction of application D. Since the number of market-wide download statistics 194 has monotonically increased, it follows that maximum market-adjusted download statistics for application C is greater than the maximum market-adjusted download statistics for application D. Accordingly, scoring application C and application D based on the maximum market-adjusted download statistics may indicate that application C is a better result than application D. For the reasons described above, scoring applications using application scoring features based on market-adjusted statistics may highlight some aspects of older applications which may assist in boosting the result scores for older application that are not performing as well as newer applications at the present time.

The techniques for performing application searches described herein with respect to FIGS. 1-8 may also be applied to searches for digital goods other than software applications. For example, the techniques described herein may be used by a digital-goods search system that is configured to search for digital goods, such as digital music, digital videos (e.g., movies and television shows), and digital books. Techniques for performing searches for digital goods are described herein with reference to FIGS. 9-12.

FIG. 9 is a functional block diagram illustrating an example environment including a digital-goods search system 400 (hereinafter “search system 400”) configured to perform searches for digital goods, such as digital music, digital videos (e.g., movies and television shows), and digital books. The search system 400 may operate in a similar manner as the search system 100. However, the search system 400 may generate search results including digital goods other than applications. For example, the search system 400 may generate search results including digital music, digital videos, or digital books.

The search system 400 is configured to receive search queries from one or more user device(s) 102 via a network 104. The search system 400 performs a search for digital goods in response to a received search query. The search system 400 may generate a set of search results that includes a list of digital goods, each of which is associated with a result score that indicates the rank of the digital good relative to the other digital goods in the list. The search system 400 may then transmit the search results to the user device that transmitted the search query.

A user device 102 may display the search results to the user and allow the user to select one of the digital goods in the list in order to view information related to the digital good, preview the digital good, and/or download the digital good. The digital goods listed in the search results sent to the user device 102 may be accessible from (e.g., downloaded from) the search system 400 or systems different than the search system 400, such as a digital-goods marketplace 402. The digital-goods marketplace 402 may be a digital distribution platform configured to distribute digital goods. For example, the digital-goods marketplace 402 may be configured to distribute digital music, digital videos, and/or digital books. Example digital-goods marketplaces include, but are not limited to, Google Play, the iTunes Store developed by Apple Inc., Amazon MP3, and Amazon Instant Video, each developed by Amazon.com Inc.

The search system 400 includes a digital-goods data store 404 and a digital-goods search module 406. The digital-goods data store 404 includes a variety of different types of data related to different digital goods. The digital-goods data store 404 may include one or more databases, indices (e.g., inverted indices), files, or other data structures which may be used to implement the techniques of the present disclosure. The data included in the digital-goods data store 404 may include descriptions of digital goods, statistics related to digital goods (e.g., download numbers, ratings numbers, and review numbers), market-adjusted statistics, market-wide statistics, digital-good scoring features, and other information. The digital-goods search module 406 receives a search query and generates search results based on the data included in the digital-goods data store 404.

The search system 400 also includes a statistics module 408. The statistics module 408 retrieves statistics from the digital-goods marketplace 402 and the data sources 410 (e.g., websites, blogs, reviews, and social networks). The statistics module 408 may store retrieved statistics in the digital-goods data store 404. The statistics module 408 may also process statistics that are retrieved or stored. For example, the statistics module 408 may generate the digital-goods statistics, market-wide statistics, and the market-adjusted statistics included in the digital-goods data store 404. The statistics module 408 may also generate digital-good scoring features based on statistics. For example, the statistics module 408 may generate digital-good scoring features based on market-adjusted statistics. The statistics module 408 may store the digital-good scoring features in the digital-goods data store 404.

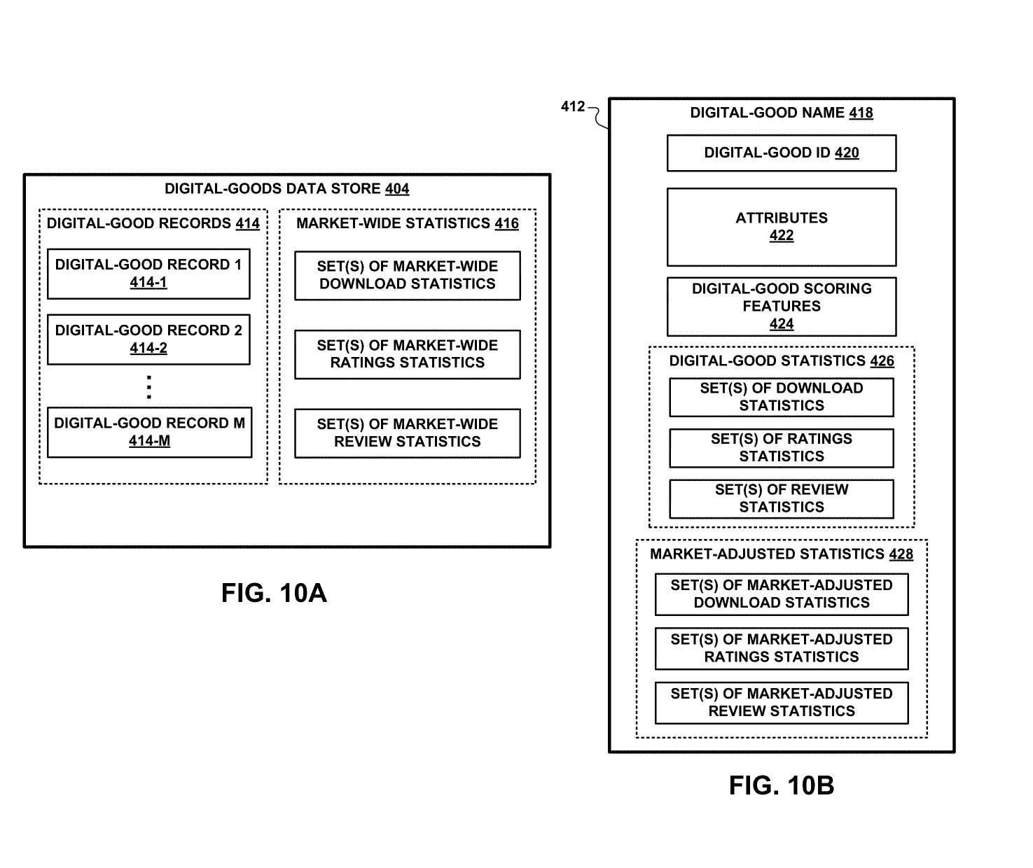

FIG. 10A shows example data which may be stored in the digital-goods data store 404. FIG. 10B shows an example digital-good record 412. The digital-good record 412 may generally represent data stored in the digital-goods data store 404 that is related to a digital-good, such as digital music, a digital video, and/or a digital book. The digital-goods data store 404 may include data related to a plurality of digital-goods. Accordingly, as illustrated in FIG. 10A, the digital-goods data store 404 includes a plurality of digital-good records 414-1, 414-2, . . . , 414-M. Additionally, the digital-goods data store 404 includes market-wide statistics 416. The search system 400 (e.g., the statistics module 408) may generate the data included in the digital-goods data store 404.

The example digital-good record 412 includes a digital-good name 418, a digital-good identifier 420, attributes 422, digital-good scoring features 424, digital-good statistics 426, and market-adjusted statistics 428. The digital-goods data store 404 may include a plurality of digital-good records having a similar structure as the digital-good record 412. The digital-good name 418 may be the name of the digital good represented by the data in the digital-good record 412. Example digital-good names may include a name of a song, an album, a video, or a book, depending on the type of digital good represented by the digital-good record 412. The digital-good identifier 420 identifies the digital-good record 412 amongst the other digital-good records included in the digital-goods data store 404.

The attributes 422 may include a variety of different data, depending on the type of digital good described by the digital-good record 412. For example, the attributes 422 may include the name of musical artists associated with digital music, actors associated with a movie, an author associated with a book, a publisher of the digital good, a genre of the digital good, a description of the digital good (e.g., a textual description), and the price of the digital good. The attributes 422 may also include information retrieved from websites such as reviews associated with the digital good, articles associated with the digital good (e.g., wiki articles), or other information. The attributes 422 may also include media related to the digital good, such as images (e.g., icons and/or screenshots).

The digital-good record 412 may include digital-good scoring features 424. The digital-good scoring features 424 may include any of the attributes 422 included in the digital-good record 412 or any additional parameters related to the digital good. The search system 400 may use the digital-good scoring features 424 to generate result scores for the digital good associated with the digital-good record 412.

The digital-good record 412 includes digital-good statistics 426. The digital-good statistics 426 may refer to numerical data related to the digital good. For example, the digital-good statistics 426 may include, but are not limited to, digital-good download statistics, digital-good ratings statistics, and digital-good review statistics. The statistics module 408 may extract or infer the digital-good statistics 426 from the digital-goods marketplace 402 and/or the data sources 410.

The digital-goods data store 404 includes one or more sets of market-wide statistics 416. Market-wide statistics may be an aggregate of digital-good statistics for a plurality of different digital goods. An example set of market-wide statistics may be a set of market-wide download statistics. Other example sets of market-wide statistics may be market-wide ratings statistics and market-wide review statistics.

The digital-good records in the digital-goods data store 404 include one or more sets of market-adjusted statistics. The statistics module 408 generates the market-adjusted statistics included in the digital-good records. The statistics module 408 generates market-adjusted statistics for a digital good based on the digital-good statistics associated with the digital good and market-wide statistics. For example, the statistics module 408 may generate market-adjusted statistics for a digital good by normalizing (e.g., dividing) the digital-good statistics by the market-wide statistics.

The statistics module 408 may generate digital-good scoring features based on market-adjusted statistics. The search system 400 may use the digital-good scoring features to generate results scores for search results. Accordingly, the search system 400 may generate result scores based on market-adjusted statistics.

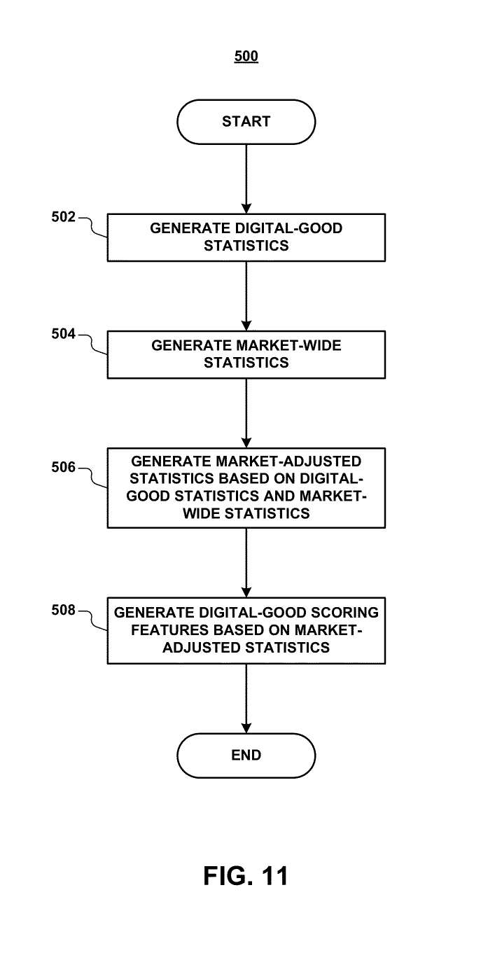

FIG. 11 shows an example method 500 for generating digital-good scoring features based on market-adjusted statistics. Initially, the statistics module 408 generates digital-good statistics in block 502. For example, the statistics module 408 may retrieve digital-good statistics reported by one or more digital-goods marketplaces (e.g., digital-goods marketplace 402) and/or the data sources 410. The statistics module 408 may store the generated digital-good statistics in the digital-goods data store 404. For example, the statistics module 408 may store one or more sets of digital-good statistics in a digital-good record.

In block 504, the statistics module 408 generates market-wide statistics. In block 506, the statistics module 408 generates market-adjusted statistics based on digital-good statistics and market-wide statistics. The statistics module 408 may generate market-adjusted statistics for a digital good by normalizing (e.g., dividing) digital-good statistics by market-wide statistics. In block 508, the statistics module 408 generates one or more digital-good scoring features based on market-adjusted statistics. For example, the statistics module 408 may generate one or more digital-good scoring features based on data point(s) retrieved from market-adjusted statistics.

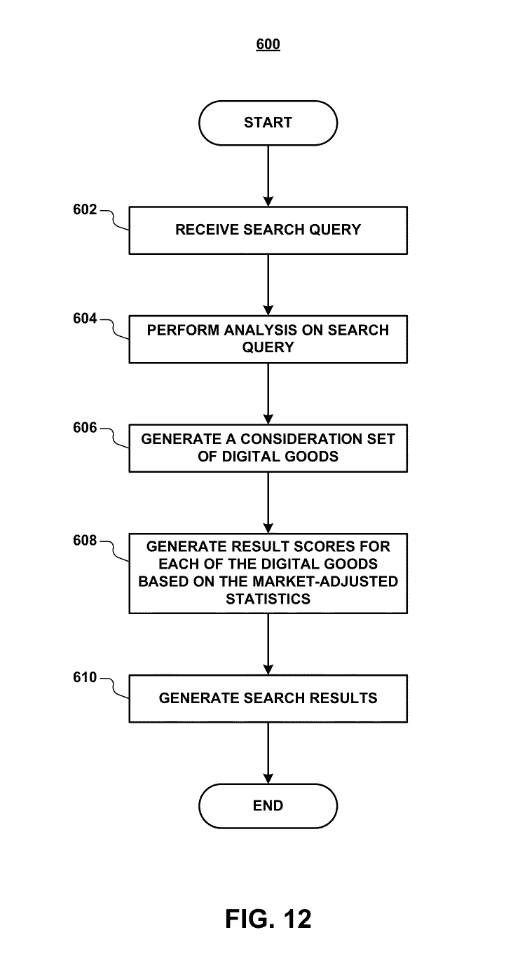

FIG. 12 shows an example method 600 for performing a search for digital goods based on a received search query. The method 600 is described with reference to the digital-goods search module 406 of FIG. 9. In block 602, the digital-goods search module 406 receives a search query that was generated by a user device 102. In block 604, the digital-goods search module 406 analyzes the search query. In block 606, the digital-goods search module 406 identifies a consideration set of digital goods (e.g., a set of digital good records) based on the search query.

In block 608, the digital-goods search module 406 generates result scores for each digital good in the set based on scoring features, such as digital-good scoring features. One or more of the digital-good scoring features may be derived from market-adjusted statistics. In block 610, the digital-goods search module 406 generates a set of search results. The search results may include a list of digital goods and associated result scores. The search system 400 may then transmit the search results to a user device 102 in some examples.

Modules and data stores included in the search systems 100, 400 represent features that may be included in the search systems 100, 400 of the present disclosure. For example, the application search module 110, the digital-goods search module 406, the statistics modules 112, 408, the application data store 108, and the digital-goods data store 404 may represent features included in the search systems 100, 400. The modules and data stores may be embodied by electronic hardware, software, firmware, or any combination thereof. Depiction of different features as separate modules and data stores does not necessarily imply whether the modules and data stores are embodied by common or separate electronic hardware or software components. In some implementations, the features associated with the one or more modules and data stores depicted herein may be realized by common electronic hardware and software components. In some implementations, the features associated with the one or more modules and data stores depicted herein may be realized by separate electronic hardware and software components.

The modules and data stores may be embodied by electronic hardware and software components including, but not limited to, one or more processing units, one or more memory components, one or more input/output (I/O) components, and interconnect components. Interconnect components may be configured to provide communication between the one or more processing units, the one or more memory components, and the one or more I/O components. For example, the interconnect components may include one or more buses that are configured to transfer data between electronic components. The interconnect components may also include control circuits (e.g., a memory controller and/or an I/O controller) that are configured to control communication between electronic components.

The one or more processing units may include one or more central processing units (CPUs), graphics processing units (GPUs), digital signal processing units (DSPs), or other processing units. The one or more processing units may be configured to communicate with memory components and I/O components. For example, the one or more processing units may be configured to communicate with memory components and I/O components via the interconnect components.

A memory component may include any volatile or non-volatile media. For example, memory may include, but is not limited to, electrical media, magnetic media, and/or optical media, such as a random access memory (RAM), read-only memory (ROM), non-volatile RAM (NVRAM), electrically-erasable programmable ROM (EEPROM), Flash memory, hard disk drives (HDD), magnetic tape drives, optical storage technology (e.g., compact disc, digital versatile disc, and/or Blu-ray Disc), or any other memory components.

Memory components may include (e.g., store) data described herein. For example, the memory components may include the application data (e.g., application records) included in the application data store 108 and the digital-goods data (e.g., digital-good records) included in the digital-goods data store 404. Memory components may also include instructions that may be executed by one or more processing units. For example, memory may include computer-readable instructions that, when executed by one or more processing units, cause the one or more processing units to perform the various functions attributed to the modules and data stores described herein.

The I/O components may refer to electronic hardware and software that provides communication with a variety of different devices. For example, the I/O components may provide communication between other devices and the one or more processing units and memory components. In some examples, the I/O components may be configured to communicate with a computer network. For example, the I/O components may be configured to exchange data over a computer network using a variety of different physical connections, wireless connections, and protocols. The I/O components may include, but are not limited to, network interface components (e.g., a network interface controller), repeaters, network bridges, network switches, routers, and firewalls. In some examples, the I/O components may include hardware and software that is configured to communicate with various human interface devices, including, but not limited to, display screens, keyboards, pointer devices (e.g., a mouse), touchscreens, speakers, and microphones. In some examples, the I/O components may include hardware and software that is configured to communicate with additional devices, such as external memory (e.g., external HDDs).

In some implementations, the search systems 100, 400 may be systems of one or more computing devices (e.g., a computer search system) that are configured to implement the techniques described herein. Put another way, the features attributed to the modules and data stores described herein may be implemented by one or more computing devices. Each of the one or more computing devices may include any combination of electronic hardware, software, and/or firmware described above. For example, each of the one or more computing devices may include any combination of processing units, memory components, I/O components, and interconnect components described above. The one or more computing devices of the search systems 100, 400 may also include various human interface devices, including, but not limited to, display screens, keyboards, pointing devices (e.g., a mouse), touchscreens, speakers, and microphones. The computing devices may also be configured to communicate with additional devices, such as external memory (e.g., external HDDs).

The one or more computing devices of a search system (e.g., 100 or 400) may be configured to communicate with the network 104. The one or more computing devices of a search system (e.g., 100 or 400) may also be configured to communicate with one another via a computer network. In some examples, the one or more computing devices of a search system (e.g., 100 or 400) may include one or more server computing devices configured to communicate with user devices (e.g., receive queries and transmit results), gather data from data sources (e.g., 114 and 410), index data, store the application data and the digital-goods data, and store other documents. The one or more computing devices may reside within a single machine at a single geographic location in some examples. In other examples, the one or more computing devices may reside within multiple machines at a single geographic location. In still other examples, the one or more computing devices of a search system (e.g., 100 or 400) may be distributed across a number of geographic locations.

Various examples have been described. These and other examples are within the scope of the following claims.

What is claimed is:

1. A method comprising:
receiving a search query from a computing device;
searching an application data store using the search query, the application data store including application data for a plurality of software applications available from a software-application marketplace configured to distribute the plurality of software applications to the computing device, the application data including a set of application statistics for each of the plurality of software applications, each set of application statistics including statistical data points over time, and the application data further including a set of market-wide statistics that is an aggregate of the sets of application statistics over time;
generating a list of software applications identified during the search of the application data store; and
for each software application in the list, generating a result score for the software application based on a set of market-adjusted statistics associated with the software application, the set of market-adjusted statistics associated with the software application being the set of application statistics associated with the software application adjusted by the set of market-wide statistics, and the result score indicating a rank of each software application among the software applications in the list.

2. The method of claim 1, further comprising transmitting the list of software applications to the computing device.

3. The method of claim 1, wherein each set of application statistics includes statistical data points indicating a number of downloads over time.

4. The method of claim 3, wherein the set of market-wide statistics indicates an aggregate of the number of downloads over time for the plurality of software applications.

5. The method of claim 3, wherein each of the statistical data points indicates a download rate.

6. The method of claim 1, wherein each set of application statistics includes statistical data points indicating at least one of a number of ratings and a number of reviews.

7. The method of claim 1, further comprising generating each set of application statistics based on numbers reported by the software-application marketplace.

8. The method of claim 1, further comprising generating the set of market-wide statistics.

9. The method of claim 1, wherein the set of market-adjusted statistics associated with the software application includes a plurality of market-adjusted data points over time, and wherein the method further comprises:
selecting a market-adjusted data point from the set of market-adjusted statistics; and
generating the result score based on the selected market-adjusted data point.

10. The method of claim 9, wherein selecting the market-adjusted data point from the set of market-adjusted statistics comprises selecting the market-adjusted data point based on the amount of time the software application associated with the set of market-adjusted statistics has been available from the software-application marketplace.

11. The method of claim 1, wherein the set of market-adjusted statistics associated with the software application includes a plurality of market-adjusted data points over time, and wherein the method further comprises:
selecting a plurality of market-adjusted data points from the set of market-adjusted statistics; and
generating the result score based on the selected market-adjusted data points.

12. The method of claim 1, wherein generating a result score for the software application based on a set of market-adjusted statistics comprises:
determining at least one of a first derivative and a second derivative of the set of market-adjusted statistics; and
generating the result score based on the at least one of the first derivative and the second derivative of the set of market-adjusted statistics.

13. The method of claim 1, wherein the set of market-adjusted statistics associated with the software application is the set of application statistics associated with the software application divided by the set of market-wide statistics.

14. The method of claim 1, wherein each software application of the plurality of software applications is associated with one of N different application categories, the application data store including N sets of market-wide statistics, each of which is associated with a different application category, and wherein the set of market-adjusted statistics associated with the software application is the set of application statistics associated with the software application adjusted by the set of market-wide statistics associated with the application category of the software application.

15. A system comprising:
an application data store that includes application data for a plurality of software applications available from a software-application marketplace configured to distribute the plurality of software applications to a remote computing device, the application data including a set of application statistics for each of the plurality of software applications, each set of application statistics including statistical data points over time, and the application data further including a set of market-wide statistics that is an aggregate of the sets of application statistics over time; and
one or more computing devices configured to:
receive a search query from the remote computing device;
search the application data store using the search query;
generate a list of software applications identified during the search of the application data store; and
for each software application in the list, generate a result score for the software application based on a set of market-adjusted statistics associated with the software application, the set of market-adjusted statistics associated with the software application being the set of application statistics associated with the software application adjusted by the set of market-wide statistics, and the result score indicating a rank of each software application among the software applications in the list.

16. The system of claim 15, wherein each set of application statistics includes statistical data points indicating a number of downloads over time.

17. The system of claim 16, wherein the set of market-wide statistics indicates an aggregate of the number of downloads over time for the plurality of software applications.

18. A method comprising:
receiving a search query from a computing device;
search a digital-goods data store using the search query, the digital-goods data store including digital-goods data for a plurality of digital goods available from a digital-goods marketplace configured to distribute the plurality of digital goods to the computing device, the digital-goods data including a set of digital-good statistics for each of the plurality of digital goods, each set of digital-good statistics including statistical data points over time, and wherein the digital-goods data includes a set of market-wide statistics that is an aggregate of the sets of digital-good statistics over time;
generating a list of digital goods identified during the search of the digital-goods data store; and
for each digital good in the list, generating a result score for the digital good based on a set of market-adjusted statistics associated with the digital good, the set of market-adjusted statistics associated with the digital good being the set of digital-good statistics associated with the digital good adjusted by the set of market-wide statistics, and the result score indicating a rank of each digital good among the digital goods in the list.

19. The method of claim 18, wherein the plurality of digital goods includes at least one of a digital music file, a digital movie, and a digital book.

20. The method of claim 18, wherein each set of digital-good statistics includes statistical data points indicating a number of downloads over time.

21. The method of claim 20, wherein the set of market-wide statistics indicates an aggregate of the number of downloads over time for the plurality of digital goods.
